(19) United States
(12) Patent Application Publication
(10) Pub. No.: US 2004/0113037 A1
(43) Pub. Date: Jun. 17, 2004

(54) Bookstand that folds thin enough to serve as a bookmark

(76) Inventor: Ronald S. Lane, New York, NY (US)

Correspondence Address: Ron Lane, 2 Kakiat Lane, Spring Valley, NY, 10977

(21) Appl. No.: 10/605,663

(22) Filed: Oct. 16, 2003

(30) Foreign Application Priority Data
Oct. 18, 2002 (EP) 842758102US

(51) Int. Cl. B42D 9/00

(52) U.S. Cl. 248/459; 116/234; 281/42

(57) ABSTRACT

A bookstand made up of a thin material that when in its folded out position receives a book so that the back of the book is tilted up to make its pages more easily viewed by the reader, and that can be folded flat enough to be placed inside the pages of the book so that it can be used as a bookmark.

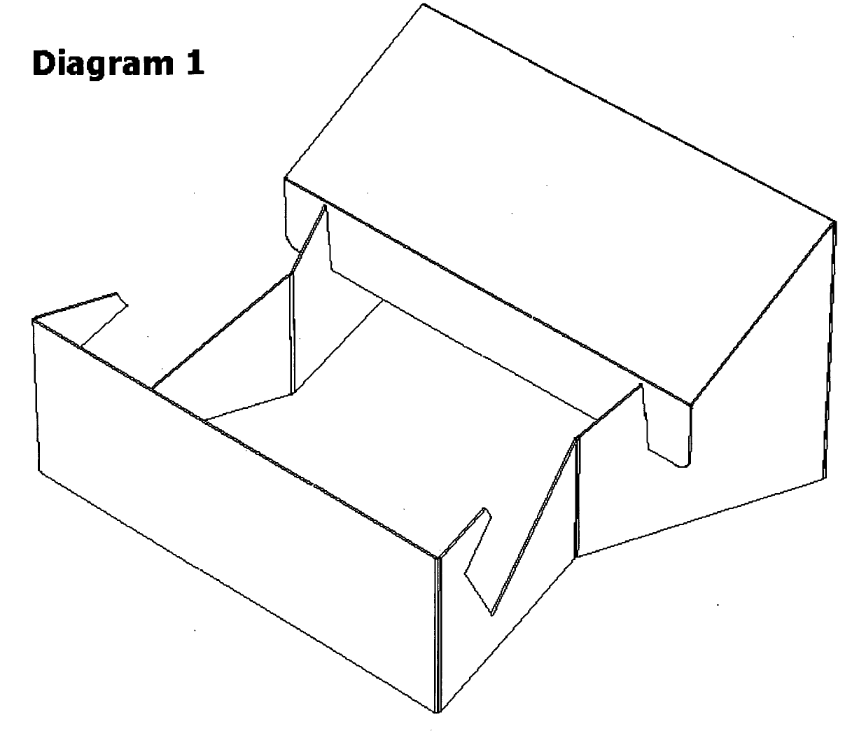

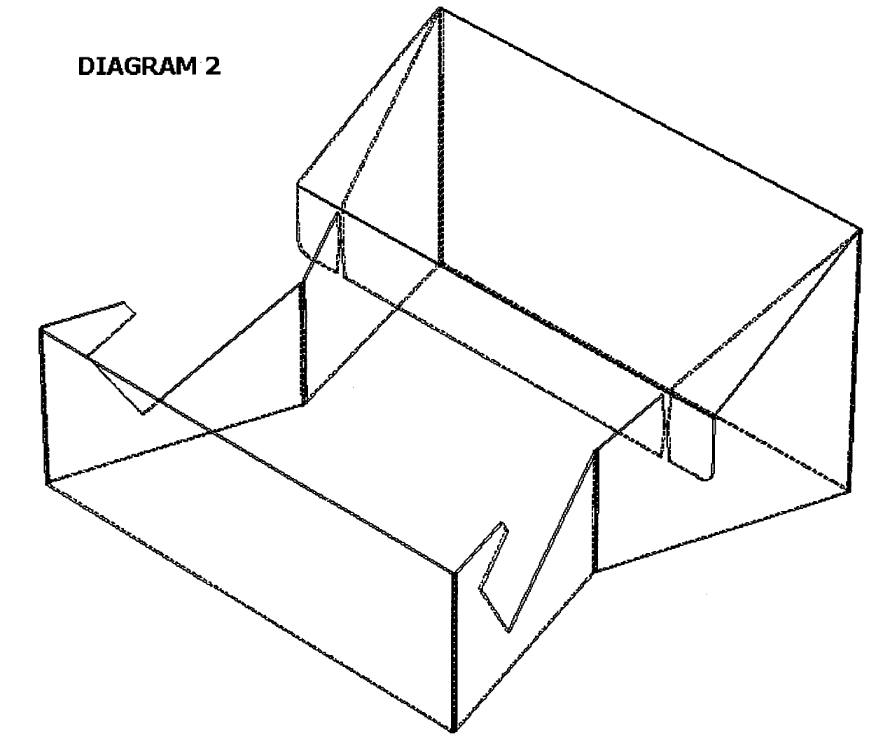

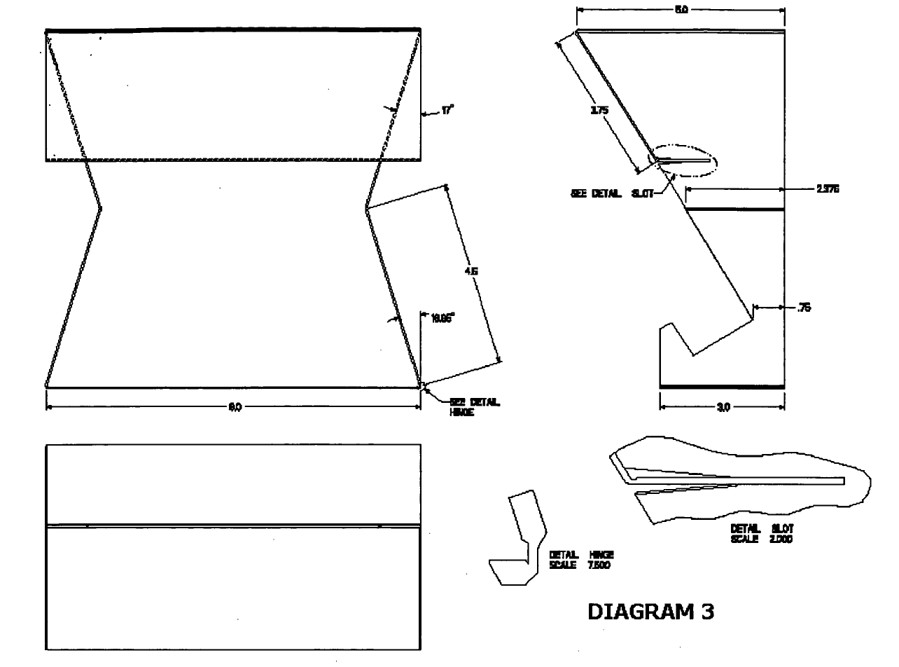

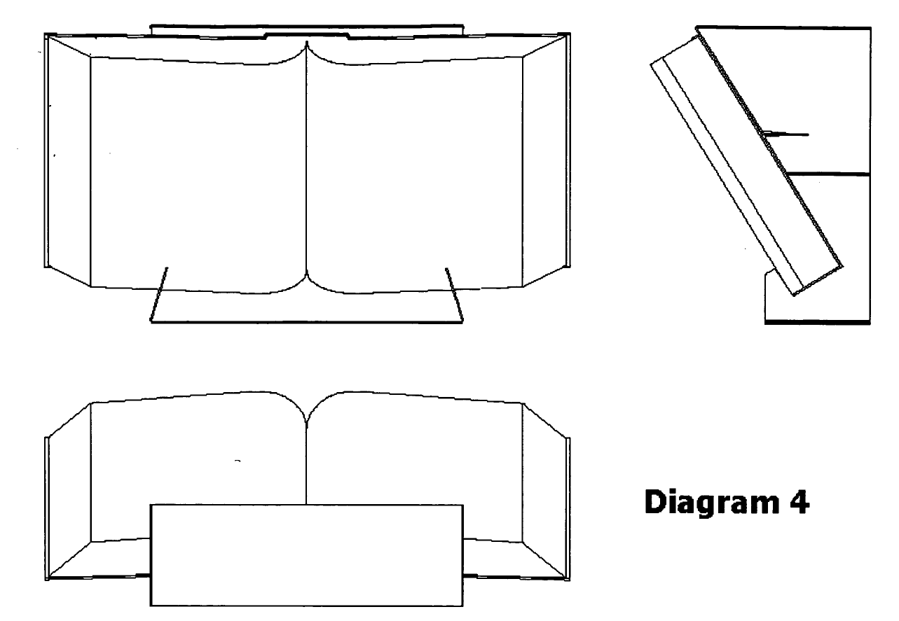

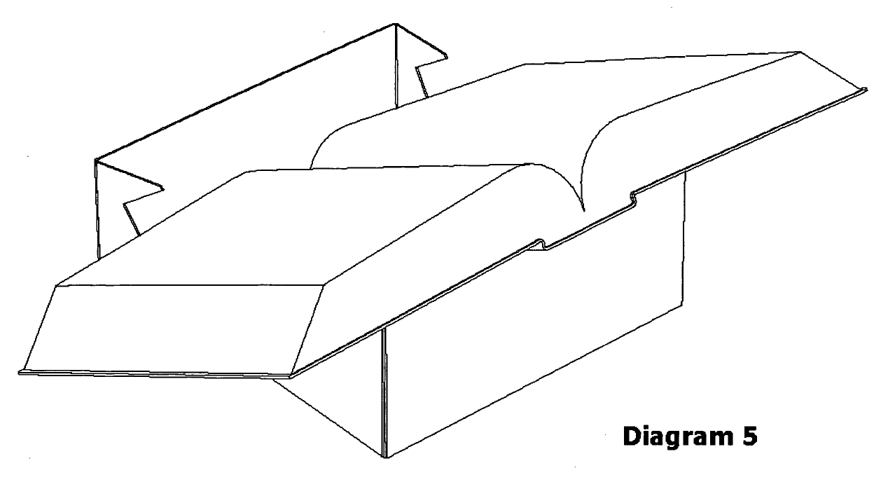

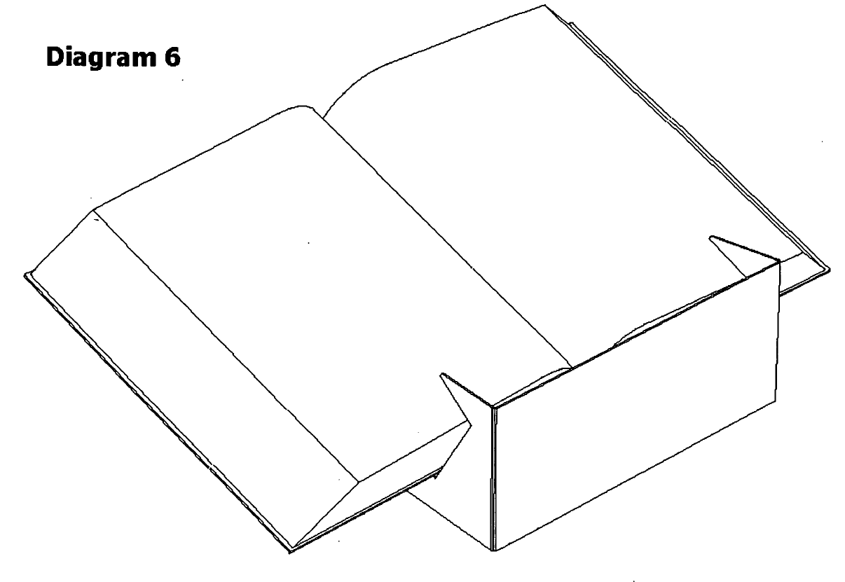

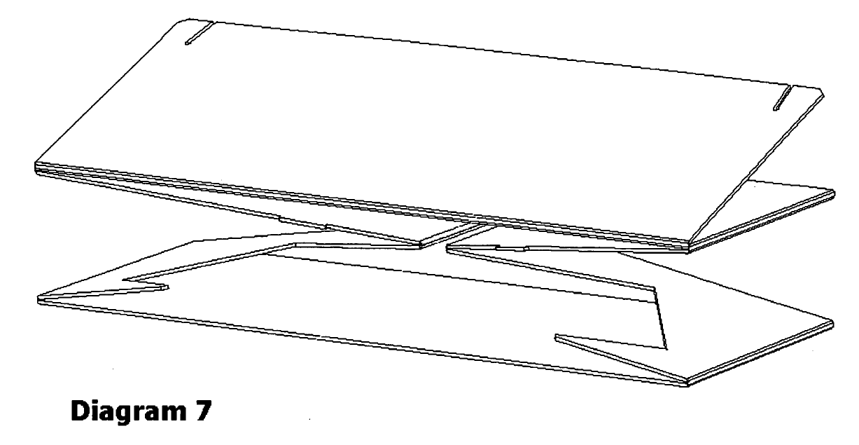

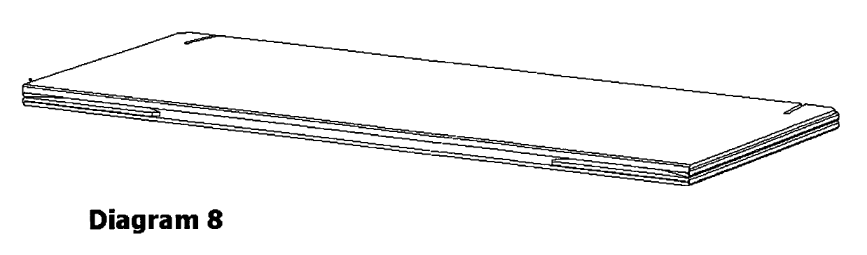

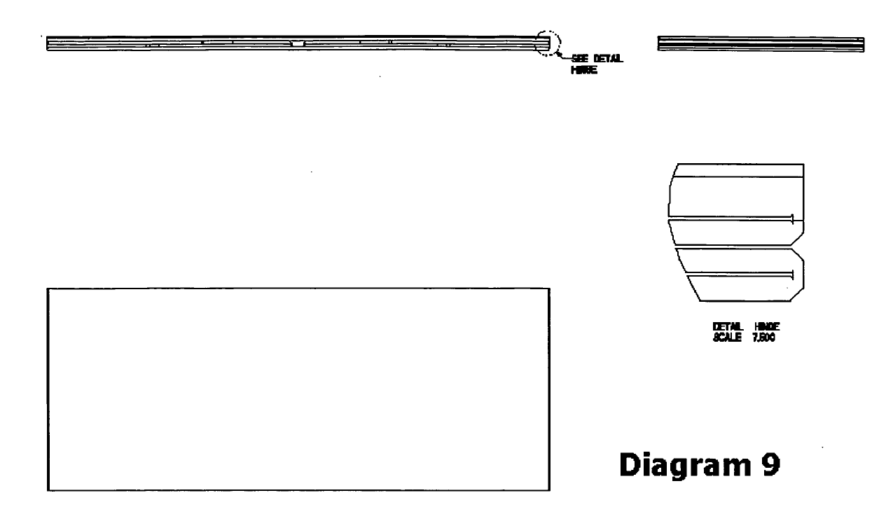

### SUMMARY OF INVENTION

The invention which we call a “thinstand™”—serves the basic purpose of most bookstands, e.g. tilting the back of the book up towards the reader so that its pages are viewed more directly and easily. The major improvement of the invention is that it can fold flat when not serving as a bookstand—flat enough to be stored in the book when not being used, so it can serve the additional purpose of being used as a bookmark.

### DETAILED DESCRIPTION

This patent application is a continuation of the provisional patent filed on Oct. 18, 2002, by Ronald S. Lane. The Express Mail Label Number was EU842758102US

If you do a patent search for “bookstands”, you will find hundreds of patented inventions. The main purpose of a bookstand is to overcome the problem that when you read a book that is lying on a desk, it is not fully facing you but angled away from you, reducing your vision of the book. Most bookstands lift the back of the book so that the pages of the book face the reader more directly. Since a bookstand needs to support the weight of the book, it is often made of a substantial material, such as metal or wood. The disadvantage of such bookstands is that they are bulky and inconvenient to carry around. It becomes an additional item to transport along with the book.

Our invention which we call a “thinstand™”—serves the basic purpose of most bookstands, e.g. tilting the back of the book up towards the reader. The major difference with our invention is that it can fold flat when not serving as a bookstand. This has some important advantages:

It is thin, light, and very convenient to carry around, because it can be put flat into the pages of the book itself.

When it is put into the book, it can be placed at the page the reader is up to, thereby also serving as a bookmark.

It can be made very inexpensively from such materials such as thin plastic or cardboard.

It has a large flat surface area that faces the reader, making it an ideal “advertising specialties item”, especially since it can be made so inexpensively.

In the current embodiment of the invention, the material used for the bookstand is plastic, since it folds easily with what is called a “living hinge” One material that we have found works well is polyurethane, though it can be made of a large number of plastics and a large number of other materials. For these reasons, our invention is novel, inventive, and very useful.

We will now describe the invention by referring to a series of 9 drawings. Some of the drawings reflect an older embodiment of the invention, but most of them refer to a newer embodiment. The difference lies in how the back plane surface that the back of the book rests on locks into place into the legs that support it to that back plane.

Diagram 1 shows the stand fully unfolded ready to receive a book. A flap that is folded down and “locked” into place keeps the stand from “unfolding” itself, and bears the weight of the book. This flap includes a “lip” that has two notches that fits into corresponding notches in the upper part of each of the legs.

Diagram 2 is very similar to diagram 1, but is a “see-through” version where you can see the lines that are behind the surfaces in diagram 1.

Diagram 3 shows three views of the stand. The upper left shows the top view, and the upper right shows the side view. The bottom shows the fully frontal view, which has a large surface to put “ad specialty” imprinting.

Diagram 4 shows the stand with a book resting on it from three additional angles. The upper left view shows it from above, the upper right shows it from the side, and the bottom drawing shows it from in front.

Diagram 5 shows the stand with a book resting on it from the viewpoint of someone looking from behind the stand, with the person facing the other person who would be reading the book.

Diagram 6 shows the stand with a book resting on it from the viewpoint of someone looking from in front of the stand.

Diagram 7 shows the stand in the act of being folded.

Diagram 8 shows the stand in its fully folded position, and shows how tidy and thin it is in this position. When the stand is made of a thin, sturdy plastic, the stand can even be thinner than it is pictured here, and can serve the purpose of being used as a bookmark.

Diagram 9 shows the stand in its fully folded position from three additional viewpoints. If we imagine that the stand is standing upright, perpendicular to the table, the upper left view shows it from above, and the upper right view shows it from the side. The lower left view shows it from the front. The lower right view is a detail of the “hinge” that permits the folding. In plastic this is often accomplished by using what is called a “living hinge

1. A bookstand made of a thin material that when it is in expanded position supports a book at an angle conducive to viewing, and that folds flat and thin enough to be used as a bookmark.
